(19) United States
(12) Patent Application Publication
(10) Pub. No.: US 2014/0089573 A1
(43) Pub. Date: Mar. 27, 2014

(54) METHOD FOR ACCESSING MEMORY DEVICES PRIOR TO BUS TRAINING

(71) Applicants: Palsamy Sakthikumar, Puyallup, WA (US); Eswaramoorthi Nallusamy, Puyallup, WA (US); Rahul Khanna, Portland, OR (US); Kuljit S. Bains, Olympia, WA (US)

(72) Inventors: Palsamy Sakthikumar, Puyallup, WA (US); Eswaramoorthi Nallusamy, Puyallup, WA (US); Rahul Khanna, Portland, OR (US); Kuljit S. Bains, Olympia, WA (US)

(21) Appl. No.: 13/625,673

(22) Filed: Sep. 24, 2012

(51) Int. Cl. G06F 12/00

(52) U.S. Cl. 711/105; 711/E12.001

(57) ABSTRACT

Embodiments of the invention describe apparatuses, systems and methods for enabling memory device access prior to bus training, thereby enabling firmware image storage in non-flash nonvolatile memory, such as DDR DRAM. The increasing size of firmware images, such as BIOS, MRC, and ME firmware, makes current non-volatile storage solutions, such as SPI flash memory, impractical; executing BIOS code in flash is slow, and having a separate non-volatile memory device increases device costs. Furthermore, solutions such as Cache-as-RAM, which are utilized for running the pre-memory BIOS code, are limited by the cache size that is not scalable to the increasing complexity of BIOS code.

Embodiments of the invention enable the use of persistent memory, such as DRAM, for BIOS code execution and data transfer by allowing DRAM access before memory channel training; said firmware images may then executed to “train” memory channels for subsequent system use.

### FIELD

Embodiments of the invention generally pertain to computing devices and more particularly to enabling memory device accessibility prior to bus training.

### BACKGROUND

Computing devices commonly use Serial Peripheral Interface (SPI) flash devices for storing firmware images, such as Basic Input/Output System (BIOS) images; however as the size of firmware images increase, the cost of increasing the storage capability of SPI flash devices increases the manufacturing costs of computing devices. What is needed is a solution to support different methods for storing firmware images with minimal changes to the platform hardware design of a computing device.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram of selected components of a computing system utilizing an embodiment of the invention.

FIG. 2 is a flow diagram of a process for accessing DDR memory before bus training according to an embodiment of the invention.

FIG. 3 is a line chart illustrating untrained memory reads according to an embodiment of the invention.

FIG. 4 is a block diagram of a client device for utilizing system non-volatile memory for firmware storage devices according to an embodiment of the invention.

Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

### DESCRIPTION

Embodiments of the invention describe apparatuses, systems and methods for enabling memory device access prior to bus training, thereby enabling firmware image storage in non-flash nonvolatile memory, such as double data rate (DDR) Dynamic Random Access Memory (DRAM) devices (for example, DRAM devices consistent with the double data rate specification 3 (DDR3, as defined by JEDEC JESD79-3)).

The increasing size of firmware images, such as pre-memory Basic Input/Output (BIOS) code for performing processor interconnect and memory initialization, makes current non-volatile storage solutions, such as Serial Peripheral Interface (SPI) flash memory, impractical; executing BIOS code in flash memory is slow, and having a separate non-volatile memory device for firmware storage increases computing device costs. Furthermore, solutions such as Cache-as-RAM (CAR/NEM), which are utilized for running the pre-memory BIOS code, are limited by the cache size of a computing device—which is not scalable to the increasing complexity of the BIOS code.

Embodiments of the invention enable the use of persistent memory for BIOS code execution and data transfer by enabling access to the persistent memory prior to the execution of any memory channel training process. For example, embodiments of the invention enable DRAM access before the execution of DDR memory channel training Embodiments of the invention thus allow the size of firmware images such as BIOS, Memory Initialization Reference Code (MRC), Manageability Engine (ME) firmware, to have no effect on computing device complexity by allowing said images to be stored on existing system memory; said firmware images may include instructions for “training” memory channels for subsequent system use.

In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

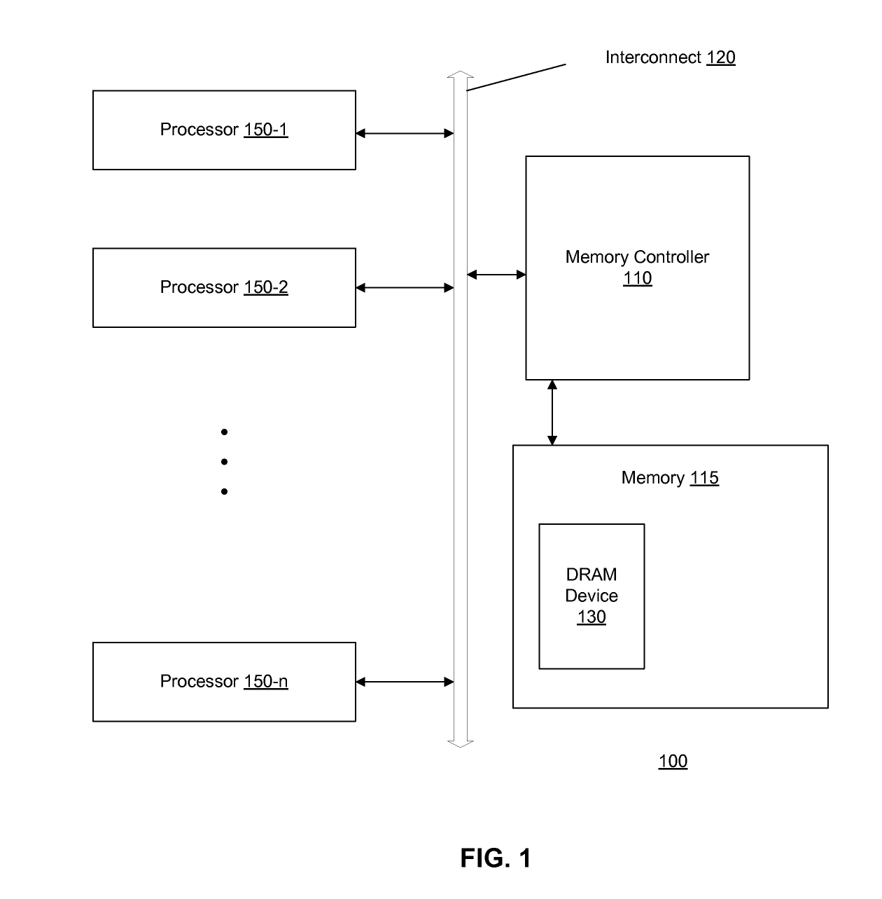

FIG. 1 is a block diagram of selected components of a computing system utilizing an embodiment of the invention. Computing system 100 includes a plurality of processors (e.g., central processing units and/or cores) 150-1 through 150-n, memory controller 110, memory 115 including (at least one) DRAM memory device 130, and interconnect 120. Memory controller 110 controls, at least in part, the transfer of information between system components and memory 115, and thus the transfer of information between system components and DRAM device 130 (which may further include a device memory controller). Said system components may include processors 150-1 through 150-n, an input/output device (e.g., a peripheral component interconnect (PCI) of PCI express (PCIe) device), memory itself, or any other system component that requests access to memory 115. In other embodiments, memory controller 110 may be included (or integrated) with a system processor (alternatively referred to herein as an integrated Memory Controller (iMC)).

In this embodiment, memory controller 110 is responsible for “enabling” DRAM 130 (e.g., asserting a “clock enable” signal), and for providing high level control of one or more channel controllers, each of which interfaces via one or more communication links to DRAM memory 130. Said channel controller contains circuits that can adjust the delay of the channel controller's transmitter and receiver to ensure that writes from the controller and reads from the DRAM work correctly. That may be accomplished by BIOS writing data patterns to and reading the stored data patterns from DRAM memory 130 over the DDR channel while dynamically setting delays and other training parameters via PCI/PCIe accesses. This process is herein referred to as DDR training.

During DDR training a channel controller writes a data pattern to memory, and then reads the data back from memory and compares the data read with the write data. If the comparison is successful, then the write and read delays are determined to have performed satisfactorily. If the comparison is unsuccessful, either or both of the delays are determined to be incorrect. After each comparison, a new delay setting is written to the channel controller and the process is repeated until the comparisons are completed. The training identifies the successful delay settings (note that more than one delay setting may work). Thus, for each read delay, multiple write delays are tested and for each write delay, multiple read delays may be utilized until satisfactory results are obtained.

As described below, embodiments of the invention enable access to DRAM memory 130 before the DDR channels are trained, thereby allowing persistent code and data stored to be stored in the DRAM memory rather than another non-volatile memory device (e.g., SPI flash). In some embodiments, to ensure proper data transmission over an untrained channel, a “gear down” mode is used for commands and the requested data is repeated over entire burst durations for data transfer. To improve the channel reliability further, said DDR channel may be configured to operate at its lowest speed when the system is coming out of reset.

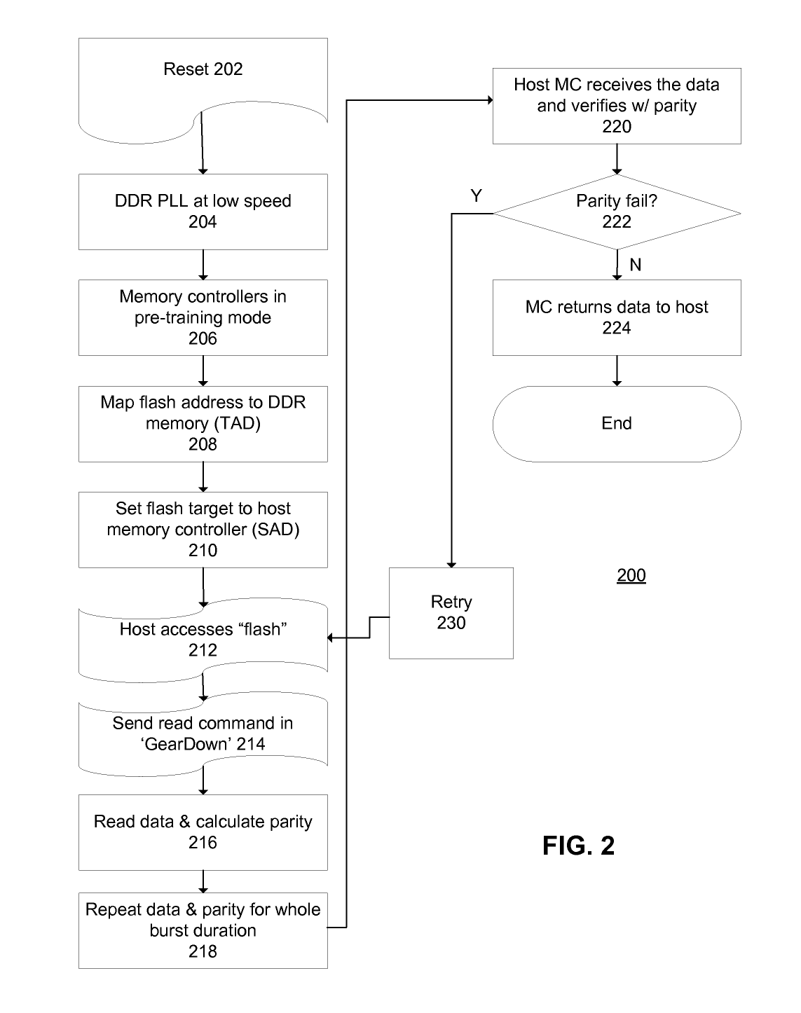

FIG. 2 is a flow diagram of a process for accessing DDR memory before bus training according to an embodiment of the invention. Flow diagrams as illustrated herein provide examples of sequences of various process actions. Although shown in a particular sequence or order, unless otherwise specified, the order of the actions can be modified. Thus, the illustrated implementations should be understood only as examples, and the illustrated processes can be performed in a different order, and some actions may be performed in parallel. Additionally, one or more actions can be omitted in various embodiments of the invention; thus, not all actions are required in every implementation. Other process flows are possible.

Process 200 includes operations executed after a system exits a reset state, 202; upon coming out of reset, phased locked loop (PLL) elements for DDR memory modules are set to operate at low speeds, 204. Said PLL elements generate a modified reference that has a fixed relation to the phase of the reference clock. A host system memory controller (e.g., an iMC) and the respective DDR memory device controller are also in pre-training mode (i.e., are operating before execution of the DDR training process described above) coming out of system reset, 206.

The host system memory controller maps “flash addresses” of a target address decoder (TAD) to the DDR memory modules, 208, while flash targets of a system address decoder (SAD) are mapped to the host system memory controller, 210. As used herein, a SAD provides the requirements and rules of the system memory configuration, while a TAD provides the requirements and rules of the memory modules connecting to their home agent within a socket. This prevents addresses from drifting from one region into another, which is illegal because the translation process happens after the SAD/TAD are decoded.

In other words, after reset the host memory controller and the DDR memory controller are operated in a pre-training memory mode, and host processor address decoding logic points to host memory controller for firmware/BIOS address space—i.e., instead of pointing to another non-volatile memory device, as is done in the prior art. The DDR memory controller maps this other non-volatile memory device and configuration data into predefined DDR addresses. When a host agent such as a processor attempts to access this other non-volatile memory device, the host memory controller issues memory accesses to said mapped DDR DRAM region.

In other words, embodiments of the invention enable system components that are configured to expect said “other non-volatile memory device” are able to transparently utilize DDR DRAM memory for accessing said firmware images. Thus, when a host device (e.g., a host processor) attempts to access a “flash device,” 212, the host memory controller sends a read command to the DDR memory controller 214. In this embodiment, this read command is executed in a gear down mode. The target operating speed of a DDR memory device is a high operating speed (e.g., for DDR4 devices, the speed may be 3,200 Mbps). In such a high speed operation, it may be difficult to achieve a high productivity while ensuring a setup/hold margin between a command and a clock, as the communication links between the host and the memory modules have not been “trained.” Thus, a memory device may use an internal clock whose frequency is lowered to (for example) half the frequency of data clocks. This mode is herein referred to as a gear down mode.

The DDR memory controller reads the data from the DDR memory and, in this embodiment, calculates related parity data, 216. The DDR memory controller transmits the data (and parity data if calculated) to the host, 218. In this embodiment, the data is transmitted for a whole burst duration (i.e., a contiguous burst of data that satisfies the memory requirements of the DDR memory). Thus, in this embodiment the host memory controller and the DRAM memory controller repeat data transmissions for entire burst length; for example, 8 bytes of data (64 bits out of 72 bits) may be available during an entire burst duration, with the remaining bits being parity data.

The host memory controller receives the data from the DDR memory controller, 220, and checks the related parity data, 222. If the parity data indicates the data is valid, the memory controller returns the data to the host, 224. If the parity data indicates that the data is invalid, the host attempts to re-access the “flash device,” 230.

Thus, in this embodiment, to compensate for absence of link training, control and command signals transmitted between the host memory controller and the DRAM memory controller are executed in a “gear down” mode and data is repeated during an entire burst duration. This process ensures reliable memory data transfer and enables the execution of MRC/BIOS code from memory instead of a separate non-volatile memory storage device, such as Platform Controller Hub (PCH) SPI flash device.

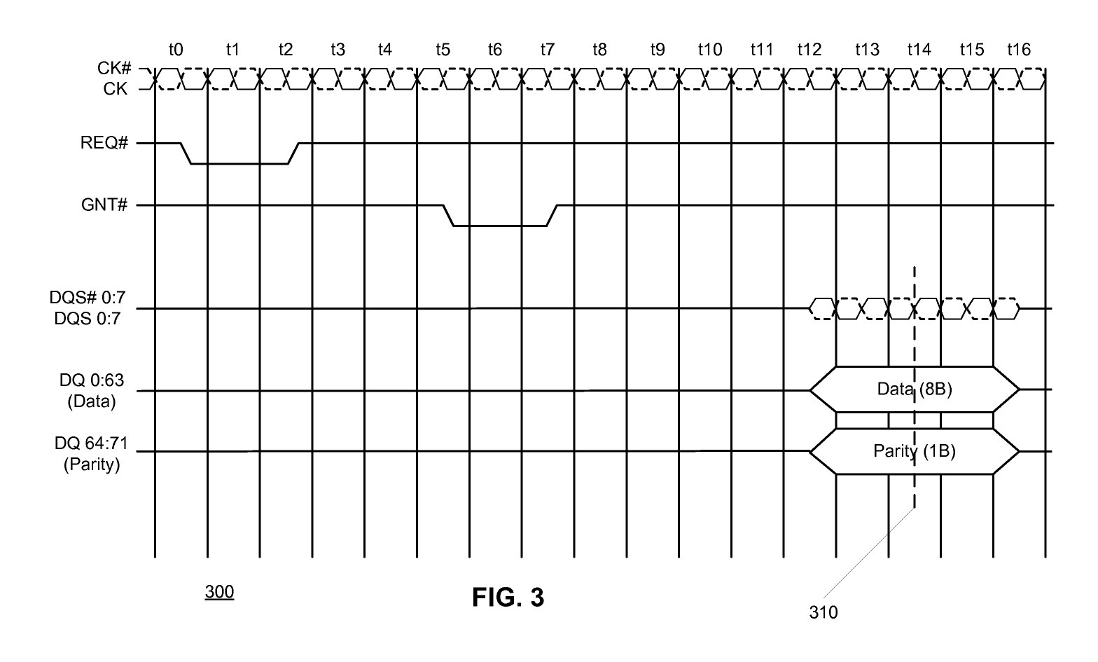

FIG. 3 is a line chart illustrating untrained memory reads according to an embodiment of the invention. Diagram 300 illustrates an example read response from a DRAM memory controller. Said DRAM memory controller receives a read command and some undefined clocks later (shown as signals CK#/CK) when the data is ready, the controller asserts a data request signal (shown as REQ#). The memory controller asserts a grant signal (shown as GNT#) a number of clocks later.

Upon observing that the grant signal has been asserted, the DRAM memory controller is shown to repeat 8 bytes of data+8 bits of parity (i.e., 1 bit per a data byte) over an entire duration of a burst. In this diagram, this operation is shown as the transmission of data signals DQ 0:63 (for the 8 bytes of data) and data signals DQ 64:71 (for the 8 bits of parity) for eight clock cycles. In this embodiment, system memory controller counts the data strobes (shown as signals DQS#/DQS) and samples the data at the middle strobe, illustrated in diagram 300 as sample time 310. Thus, in pre-training memory mode, embodiments of the invention exchange command and control signals in a “gear down” mode (as described above). The first part of the command may carry part of the address and command bits while the second part of the command may carry the Read ID (RID) and the rest of the address and command bits.

As described above, the host memory controller may calculate data parity and verify this parity value against the received parity byte DQ 64:71 (which is passed as part of the data response). If this parity comparison fails, the host memory controller may retry the transaction for a predetermined number of times. If the parity comparison matches, the host memory controller returns the data to the host.

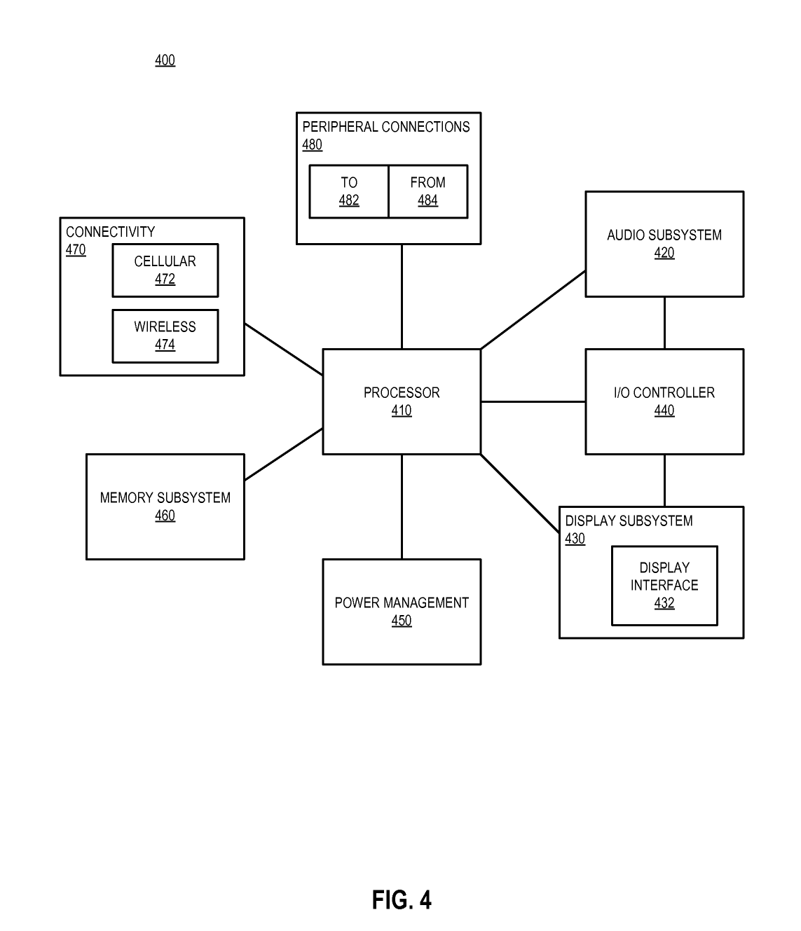

FIG. 4 is a block diagram of a client device for utilizing system non-volatile memory for firmware storage devices according to an embodiment of the invention. Computing device 400 represents a mobile computing device, such as a computing tablet, a mobile phone or smartphone, a wireless-enabled e-reader, or other wireless mobile device. It will be understood that certain of the components are shown generally, and not all components of such a device are shown in device 400.

Device 400 includes processor 410, which performs the primary processing operations of device 400. Processor 410 can include one or more physical devices, such as microprocessors, application processors, microcontrollers, programmable logic devices, processor cores, or other processing means. The processing operations performed by processor 410 include the execution of an operating platform or operating system on which applications and/or device functions are executed. The processing operations include operations related to I/O (input/output) with a human user or with other devices, operations related to power management, and/or operations related to connecting device 400 to another device. The processing operations may also include operations related to audio I/O and/or display I/O.

In one embodiment, device 400 includes audio subsystem 420, which represents hardware (e.g., audio hardware and audio circuits) and software (e.g., drivers, codecs) components associated with providing audio functions to the computing device. Audio functions can include speaker and/or headphone output, as well as microphone input via any of the audio jacks described above. Devices for such functions can be integrated into device 400, or connected to device 400. In one embodiment, a user interacts with device 400 by providing audio commands that are received and processed by processor 410.

Display subsystem 430 represents hardware (e.g., display devices) and software (e.g., drivers) components that provide a visual and/or tactile display for a user to interact with the computing device. Display subsystem 430 includes display interface 432, which includes the particular screen or hardware device used to provide a display to a user. In one embodiment, display interface 432 includes logic separate from processor 410 to perform at least some processing related to the display. In one embodiment, display subsystem 430 includes a touchscreen device that provides both output and input to a user.

I/O controller 440 represents hardware devices and software components related to interaction with a user. I/O controller 440 can operate to manage hardware that is part of audio subsystem 420 and/or display subsystem 430. Additionally, I/O controller 440 illustrates a connection point for additional devices that connect to device 400 through which a user might interact with the system. For example, devices that can be attached to device 400 might include microphone devices, speaker or stereo systems, video systems or other display device, keyboard or keypad devices, or other I/O devices for use with specific applications such as card readers or other devices.

As mentioned above, I/O controller 440 can interact with audio subsystem 420 and/or display subsystem 430. For example, input through a microphone or other audio device can provide input or commands for one or more applications or functions of device 400. Additionally, audio output can be provided instead of or in addition to display output. In another example, if display subsystem includes a touchscreen, the display device also acts as an input device, which can be at least partially managed by I/O controller 440. There can also be additional buttons or switches on device 400 to provide I/O functions managed by I/O controller 440.

In one embodiment, I/O controller 440 manages devices such as accelerometers, cameras, light sensors or other environmental sensors, or other hardware that can be included in device 400. The input can be part of direct user interaction, as well as providing environmental input to the system to influence its operations (such as filtering for noise, adjusting displays for brightness detection, applying a flash for a camera, or other features). In one embodiment, device 400 includes power management 450 that manages battery power usage, charging of the battery, and features related to power saving operation.

Memory subsystem 460 includes memory devices for storing information in device 400. Memory can include nonvolatile (state does not change if power to the memory device is interrupted) and/or volatile (state is indeterminate if power to the memory device is interrupted) memory devices. Memory 460 can store application data, user data, music, photos, documents, or other data, as well as system data (whether long-term or temporary) related to the execution of the applications and functions of system 400. Memory 460 further stores firmware images related to boot path operations, and thus may include DRAM devices to store said firmware images as described above.

Connectivity 470 includes hardware devices (e.g., wireless and/or wired connectors and communication hardware) and software components (e.g., drivers, protocol stacks) to enable device 400 to communicate with external devices. The device could be separate devices, such as other computing devices, wireless access points or base stations, as well as peripherals such as headsets, printers, or other devices.

Connectivity 470 can include multiple different types of connectivity. To generalize, device 400 is illustrated with cellular connectivity 472 and wireless connectivity 474. Cellular connectivity 472 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, or other cellular service standards. Wireless connectivity 474 refers to wireless connectivity that is not cellular, and can include personal area networks (such as Bluetooth), local area networks (such as Wi-Fi), and/or wide area networks (such as Wi-Max), or other wireless communication.

Peripheral connections 480 include hardware interfaces and connectors for implementing non-flash firmware storage support as described above, as well as software components (e.g., drivers, protocol stacks) to make peripheral connections. It will be understood that device 400 could both be a peripheral device (“to” 482) to other computing devices, as well as have peripheral devices (“from” 484) connected to it. Device 400 commonly has a “docking” connector to connect to other computing devices for purposes such as managing (e.g., downloading and/or uploading, changing, synchronizing) content on device 400. Additionally, a docking connector can allow device 400 to connect to certain peripherals that allow device 400 to control content output, for example, to audiovisual or other systems.

In addition to a proprietary docking connector or other proprietary connection hardware, device 400 can make peripheral connections 480 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other type.

Embodiments of the invention thus describe systems including an antenna, radio frequency circuitry coupled to the antenna to receive signal data to be processed by the system, a double data rate (DDR) memory device including a firmware image, a processor to request access to the firmware image, and a memory controller, said memory controller is to receive the request from the processor for the firmware image stored on the DDR memory device, initiate the transfer of the firmware image data from the DDR memory to the processor, and subsequent to the transfer of the firmware image data, execute a link training process to determine timing delays associated with one or more interface signals to the DDR memory device.

In some embodiments, said firmware image data comprises a basic input/output system (BIOS) image, and said link training process comprises operations included in the BIOS image. In other embodiments, said firmware image data comprises one of a graphics card firmware image or a manageability engine (ME) firmware image.

In some embodiments, said memory controller may further initiate the transfer of parity data associated with the firmware image data to the memory controller. In some embodiments, said DDR memory device is configurable to operate at a plurality of operating speeds, and the memory controller further configures the DDR memory device to operate at a non-maximum operating speed. The transfer of the firmware image data from the DDR memory device may comprise a transmission of a single data segment during a burst length.

Embodiments of the invention thus describe apparatuses having arbitration logic to receive a request for access to a firmware image stored on a double data rate (DDR) memory device, and a memory controller to initiate the transfer of the firmware image data from the DDR memory in response to the arbitration logic receiving the request; subsequent to the transfer of the firmware image data, the memory controller executes a link training process to determine timing delays associated with one or more interface signals to the DDR memory device. In some embodiments, said firmware image data comprises a basic input/output system (BIOS) image, and said link training process comprises operations included in the BIOS image. In other embodiments, said firmware image data comprises one of a graphics card firmware image or a manageability engine (ME) firmware image.

In some embodiments, said memory controller may further initiate the transfer of parity data associated with the firmware image data to the memory controller. In some embodiments, said DDR memory device is configurable to operate at a plurality of operating speeds, and the memory controller further configures the DDR memory device to operate at a non-maximum operating speed. The transfer of the firmware image data from the DDR memory device may comprise a transmission of a single data segment during a burst length.

Embodiments of the invention describe methods having operations for receiving a request from a processor for firmware image data stored on a double data rate (DDR) memory device, initiating the transfer of the firmware image data from the DDR memory to the processor, and subsequent to the transfer of the firmware image data, executing a link training process to determine timing delays associated with one or more interface signals to the DDR memory device. In some embodiments, said firmware image data comprises a basic input/output system (BIOS) image. In other embodiments, said firmware image data comprises one of a graphics card firmware image or a manageability engine (ME) firmware image.

In some embodiments, operations may be executed for initiating the transfer of parity data associated with the firmware image data to the memory controller. In some embodiments, said DDR memory device is configurable to operate at a plurality of operating speeds, and operations for configuring the DDR memory device to operate at a non-maximum operating speed are executed. In some embodiments, the transfer of the firmware image data from the DDR memory device to the processor comprises a transmission of a single data segment during a burst length.

Various components referred to above as processes, servers, or tools described herein may be a means for performing the functions described. Each component described herein includes software or hardware, or a combination of these. Each and all components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration) may be provided via an article of manufacture including a non-transitory, tangible computer or machine readable storage medium, which provides content that represents instructions that can be executed. The content may result in a computer performing various functions/operations described herein.

A computer readable non-transitory storage medium includes any mechanism that provides (i.e., stores and/or transmits) information in a form accessible by a computer (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A computer readable non-transitory storage medium may also include a storage or database from which content can be downloaded. Said computer readable medium may also include a device or product having content stored thereon at a time of sale or delivery. Thus, delivering a device with stored content, or offering content for download over a communication medium may be understood as providing an article of manufacture with such content described herein.

1. A system comprising:
a double data rate (DDR) memory device including a firmware image;
a processor to request access to the firmware image;
a memory controller to:
receive the request from the processor for the firmware image stored on the DDR memory device;
initiate the transfer of the firmware image data from the DDR memory to the processor; and
subsequent to the transfer of the firmware image data, execute a link training process to determine timing delays associated with one or more interface signals to the DDR memory device;
an antenna; and
radio frequency circuitry coupled to the antenna to receive signal data to be processed by the system.

2. The system of claim 1, the memory controller to further:
initiate the transfer of parity data associated with the firmware image data to the memory controller.

3. The system of claim 1, wherein the DDR memory device is configurable to operate at a plurality of operating speeds, the memory controller to further:
configure the DDR memory device to operate at a non-maximum operating speed.

4. The system of claim 1, wherein the transfer of the firmware image data from the DDR memory device to the processor comprises a transmission of a single data segment during a burst length.

5. The system of claim 1, wherein the firmware image data comprises a basic input/output system (BIOS) image.

6. The system of claim 5, wherein the link training process comprises operations included in the BIOS image.

7. The system of claim 1, wherein the firmware image data comprises one of a graphics card firmware image or a manageability engine (ME) firmware image.

8. An apparatus comprising:
arbitration logic to receive a request for access to a firmware image stored on a double data rate (DDR) memory device; and
a memory controller to:
initiate the transfer of the firmware image data from the DDR memory in response to the arbitration logic receiving the request; and
subsequent to the transfer of the firmware image data, execute a link training process to determine timing delays associated with one or more interface signals to the DDR memory device.

9. The apparatus of claim 8, the memory controller to further:
initiate the transfer of parity data associated with the firmware image data to the memory controller.

10. The apparatus of claim 8, wherein the DDR memory device is configurable to operate at a plurality of operating speeds, the memory controller to further:
configure the DDR memory device to operate at a non-maximum operating speed.

11. The apparatus of claim 8, wherein the transfer of the firmware image data from the DDR memory device comprises a transmission of a single data segment during a burst length.

12. The apparatus of claim 8, wherein the firmware image data comprises a basic input/output system (BIOS) image.

13. The apparatus of claim 12, wherein the link training process comprises operations included in the BIOS image.

14. The apparatus of claim 8, wherein the firmware image data comprises one of a graphics card firmware image or a manageability engine (ME) firmware image.

15. A method comprising:
receiving a request from a processor for firmware image data stored on a double data rate (DDR) memory device;
initiating the transfer of the firmware image data from the DDR memory to the processor; and
subsequent to the transfer of the firmware image data, executing a link training process to determine timing delays associated with one or more interface signals to the DDR memory device.

16. The method of claim 15, further comprising:
initiating the transfer of parity data associated with the firmware image data to the memory controller.

17. The method of claim 15, wherein the DDR memory device is configurable to operate at a plurality of operating speeds, the method further comprising:
configuring the DDR memory device to operate at a non-maximum operating speed.

18. The method of claim 15, wherein the transfer of the firmware image data from the DDR memory device to the processor comprises a transmission of a single data segment during a burst length.

19. The method of claim 15, wherein the firmware image data comprises a basic input/output system (BIOS) image.

20. The method of claim 15, wherein the firmware image data comprises one of a graphics card firmware image or a manageability engine (ME) firmware image.
